(19) United States
(12) Patent Application Publication
(10) Pub. No.: US 2022/0106753 A1
(43) Pub. Date: Apr. 7, 2022

(54) SPRING TENSIONED MARINE STANDOFF

(71) Applicant: John NOPPINGER, JR., Kingsville, MD (US)

(72) Inventor: John NOPPINGER, JR., Kingsville, MD (US)

(21) Appl. No.: 17/487,255

(22) Filed: Sep. 28, 2021

Related U.S. Application Data
(60) Provisional application No. 63/086,170, filed on Oct. 1, 2020.

(51) Int. Cl. E02B 3/26

(52) U.S. Cl. CPC E02B 3/26

(57) ABSTRACT

A spring tensioned marine standoff including a housing having a blocked end, an open end, and opposite side portions each including a slot and a ram disposed within the housing and including a roller mount for supporting at least one roller. The ram also includes holes for alignment with the slots of the housing. Additionally, the standoff includes a spring disposed within the housing at the blocked end thereof for applying tension to the ram and a fastener for securing the ram within the housing such that the ram is operable for movement within the housing against the tension of the spring and along a path defined by the slots of the housing.

### CROSS-REFERENCE TO RELATED APPLICATION

This application is based on and claims priority to Provisional Patent Application 63/086,170, filed on Oct. 1, 2020, the disclosure of which is incorporated by reference herein.

### BACKGROUND

### Technical Field

The present disclosure relates to a spring tensioned marine standoff.

### Related Art

Traditional bumpers, usually suspended from either the watercraft, or a pier, are used to absorb the contact between the boat and the structure during the docking process. Unfortunately, they have the tendency to move around, often allowing the craft to strike pilings or piers and damaging the watercraft's hull and rub rail. These fixed bumpers generally do not accommodate varying water levels and do not provide a tensioned resistance or positive barrier from a craft striking the piling or pier. Whips, poles with lines that tie the craft to the piling or pier, are another device designed to prevent the boat from making direct contact with the dock structures. While they can offer some protection, they ultimately still permit boats to rise and come closer to the piling or pier during tidal or other water level changes, allowing the possibility of contact between the craft and the docking structure. Additionally, whips provide a safety hazard on both the dock and the boat by virtue of the lines extending from the dock and over the watercraft. There is therefore a need for improvement with regard to marine standoffs.

The present disclosure provides a spring tensioned marine standoff that, with a simple configuration, protects a watercraft's hull and rub rail while maintaining a distance to keep the watercraft from touching a piling or dock structure. It allows for the natural motions of the craft, including tidal effects and those created by passing watercraft traffic, as well as lateral motion to provide protection from marring due to contact and/or motion. Additionally, the novel standoff generates no intrusion to the dock space or the watercraft, allows the craft to be tied closer to the dock, and stabilizes the craft for boarding and disembarking, ultimately eliminating multiple safety hazards.

### SUMMARY

An aspect of the present disclosure is a spring tensioned marine standoff including: a housing having a blocked end, an open end, and opposite side portions each including a slot; a ram disposed within the housing and including a roller mount for supporting at least one roller, the ram also including holes for alignment with the slots of the housing; a spring disposed within the housing at the blocked end thereof for applying tension to the ram; and a fastener for securing the ram within the housing such that the ram is operable for movement within the housing against the tension of the spring and along a path defined by the slot of the housing.

### BRIEF DESCRIPTION OF DRAWINGS

FIG. 1 is a perspective exploded view of the components of the spring tensioned marine standoff, according to an embodiment;

FIG. 2 is a perspective view of the spring tensioned marine standoff in the initial contact state, according to an embodiment;

FIG. 3 is a perspective view of the spring tensioned marine standoff in a compressed state, according to an embodiment;

FIG. 4 is a side view of the spring tensioned marine standoff compressed between a marine craft and a docking structure, according to an embodiment;

### DETAILED DESCRIPTION OF A PREFERRED EMBODIMENT

Detailed explanation follows regarding an example of an embodiment of the present disclosure, with reference to the drawings.

The spring tensioned marine standoff is applied as a system configured to prevent a watercraft from making contact with the docking structure and to ensure the craft is more stable and safe to board and disembark.

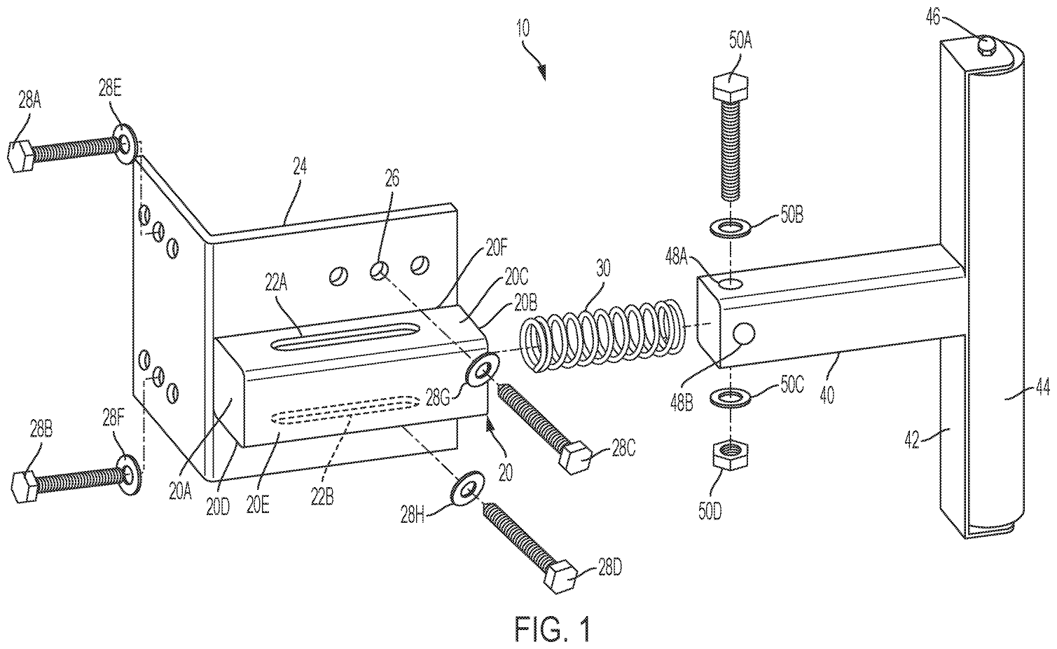

As shown in FIG. 1, the spring tensioned marine standoff 10 includes a housing 20, a ram 40 equipped with at least one roller 44, a spring 30, and a fastening system 50A-50D for alignment.

The housing 20 includes a blocked end 20A, an open end 20B, and side portions 20C-20F. The blocked end 20A may contain openings to allow for drainage of any accumulated moisture given that the available surface area is sufficient to support the spring 30. Two opposite side portions 20C and 20D each have a slot 22A and 22B, respectively. A spring 30 sits inside the housing 20 against the blocked end 20A. A mounting bracket 24 may be integrated as part of the housing 20 or be a standalone feature, separate from the housing 20.

The ram 40 includes a roller mount 42 with a roller 44 and holes 48A, 48B for alignment with the housing 20 and for orientation of the roller 44. The roller 44 is secured to the roller mount 42 by an axle 46. Although the ram 40 is shown in FIG. 1 as including a single roller 44, ram 40 may alternatively include several rollers secured to the roller mount 42 by the axle 46. The several rollers can be sized to account for varying watercraft sizes or water conditions, and the alignment holes 48A, 48B on the ram 40 allow the roller or rollers to be oriented horizontally and vertically.

In the present exemplary embodiment, the marine standoff 10 includes mounting brackets 24 for mounting the standoff 10 to a piling (or other dock structure). The brackets 24 include holes 26 and fasteners 28 for mounting the housing 10 to the piling or dock structure. The brackets may be equipped with several mounting holes to allow universal use on different docking structure sizes. Although this is merely an example, the marine standoff 10 according to the present embodiment contains mounting bracket 24 with twelve mounting holes 26. There are six holes 26 on each side of the mounting bracket 24 with three along the upper half and three along the lower half. Four stainless steel fasteners 28A, 28B, 28C, and 28D and galvanized flat washers 28E, 28F, 28G, and 28H are used, for example, with the four middle holes 26 to mount the mounting angle to the piling. The mounting bracket 24 may be integrated with the housing 20 by, for example, welding, along a side portion 20F such that the side portions 20C and 20D, with the slots 22A and 22B, are facing as shown in FIG. 1. The spring 30 sits inside the housing 20 on the inner surface of the blocked end 20A of housing 20.

As shown in FIG. 1, the ram 40 inserts through the open end 20B of the housing 20 such that the ram makes contact with the spring 30 and alignment hole 48A of the ram aligns with the slots 22A and 22B of the housing 20. Although this is merely an example, the marine standoff of the present embodiment includes a single roller oriented vertically with respect to the housing 20. The roller 44 may be made from polyurethane. Those skilled in the art will understand that the roller 44 may be made from materials other than polyurethane. A fastening system is used to secure the ram 40 within the housing 20 such that the alignment hole 48A aligns with the slots 22A and 22B of the housing. Although this is merely an example, the fastening system includes a stainless steel bolt 50A with nylon washers 50B and 50C surrounding the bolt and a stainless steel nut 50D to secure the bolt in place. The marine standoff 10 is designed to easily change the roller 44 from the vertical orientation to the horizontal orientation to accommodate varying tide conditions or to achieve the desired location necessary to meet the conditions where the craft will be docked by simply removing the fastener 50A-50D and rotating the ram 40 to align the alignment hole 48B with the slots 22A and 22B of the housing. In order for the standoff 10 to be capable of dealing with the forces and conditions attendant with watercraft docking, the various components of the standoff 10 are made of high strength structural steel with a galvanized coating to make them resistant to corrosive atmospheres and conditions. Those skilled in the art will understand that other comparable materials with similar properties may be used.

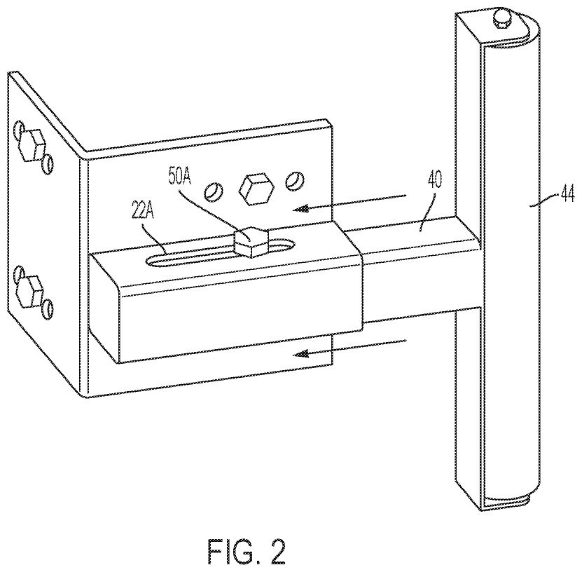

FIG. 2 shows the assembled standoff 10 with the roller 44 oriented vertically relative to the housing. As shown by the arrows in FIG. 2, when the roller 44 is contacted by a boat or other marine craft, the ram 40 begins to compress the spring 30 within the housing 20 as it moves along the path of the slots 22A and 22B. The initial contact begins at approximately 6¾ inches of separation from the docking structure. The slot allows for limited movement of the craft towards the docking structure before realizing the positive stop of the compressed spring 30.

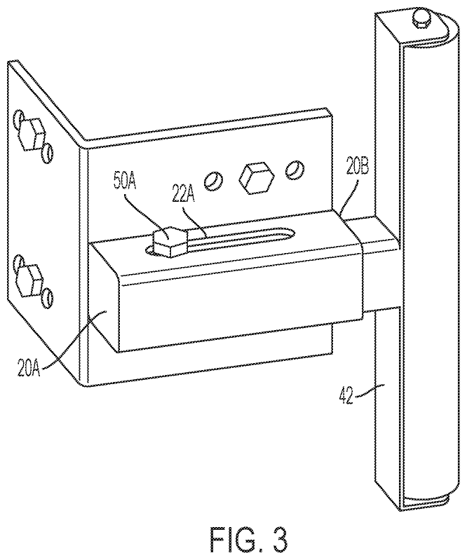

As shown in FIG. 3, the marine standoff 10 “bottoms out” when the spring 30 is fully compressed, the fastener slides to the end of the slots 22A and 22B, and the roller mount 42 makes contact with the surface of the open end 20B of the housing 20. The fully compressed spring 30, along with the fastener slide, and the roller mount 42 attached to the ram 40, all provide for a positive stop, at which point the roller 44 absorbs any remaining forces.

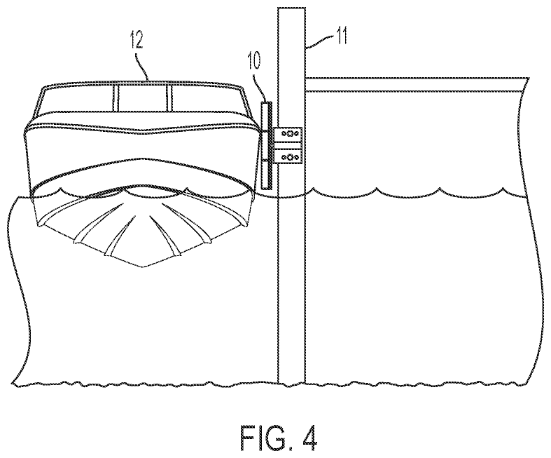

FIG. 4 depicts a docked marine craft 12 with a three-roller vertically oriented spring tensioned marine standoff 10. In general, the roller or rollers 44 can each provide a 12 inch range of contact. The one roller arrangement is generally suitable for tranquil bodies of water not subject to significant tidal rise and fall of the water level. A two-roller arrangement will provide a 24 inch range of contact, and is generally suitable for use in normal tidal areas. The three-roller arrangement shown in FIG. 4 provides a 36 inch range of contact, and is suitable for a variety of different sized hulls or tidal waves as generally incurred in coastal areas. The three-roller arrangement can be used in marinas or other locations where many different sized crafts would be encountered. Due to the fact that the standoff 10 will have its initial location well above the water level, the hull of the watercraft should not rise above the point where the standoff 10 would not contact the hull. As shown in FIG. 4, the spring tensioned marine standoff 10 allows the craft 12 to get close to the piling 11 without allowing any physical contact between the craft 12 and the piling 11. With total compression, the craft comes no closer than approximately 3¾ inches to the docking structure.

The present disclosure is not limited to the above description, and various other modifications may be implemented within a range not departing from the spirit of the present disclosure.

What is claimed is:

1. A marine standoff comprising:
a housing having a blocked end, an open end, and opposite side portions each having a slot;
a ram disposed within said housing and including a roller mount for supporting at least one roller, said ram also including holes for alignment with the slots of said side portions;
a spring disposed within said housing at the blocked end thereof for applying tension to said ram; and
a fastener for securing the ram within the housing such that the ram is operable for movement within said housing against the tension of said spring and along a path defined by the slots of said side portions.

2. The marine standoff of claim 1, further comprising:
a mounting bracket for mounting said housing to a docking structure.

3. The marine standoff of claim 1, wherein the fastener comprises a bolt disposed through the slot of one side portion of said housing and received within the hole of said ram and the slot of the opposite side portion of said housing.

4. The marine standoff of claim 1, wherein the at least one roller comprises at least two rollers.

5. The marine standoff of claim 1, wherein the at least one roller is made of polyurethane.

6. The marine standoff of claim 1, wherein said housing, ram, and spring are made from metal covered in a galvanized coating.

7. The marine standoff of claim 1, wherein the roller mount is mounted vertically with respect to the housing.

8. The marine standoff of claim 1, wherein the roller mount is mounted horizontally with respect to the housing.

9. The marine standoff according to claim 2, wherein the mounting bracket is integrated with the housing.

10. The marine standoff according to claim 3, wherein the fastener comprises a stainless steel bolt, nylon washers, and a stainless steel nut.

11. The marine standoff according to claim 1, wherein the roller mount includes an axle for mounting the roller.

12. The marine standoff according to claim 1, wherein the holes in the ram are disposed to allow the fastener to fasten the ram including the roller to the housing such that the at least one roller can be mounted one of horizontally and vertically with respect to the housing.

13. The marine standoff according to claim 1, wherein the at least one roller comprises three separate rollers.

14. The marine standoff according to claim 1 wherein at least the housing and ram are metal having a galvanized coating.

15. The marine standoff according to claim 1, wherein the roller provides at least a 12 inch range of contact.
